(19) United States
(12) Patent Application Publication
(10) Pub. No.: US 2025/0347870 A1
(43) Pub. Date: Nov. 13, 2025

(54) OPTICAL DEVICE AND METHOD OF MANUFACTURE

(71) Applicant: Taiwan Semiconductor Manufacturing Co., Ltd., Hsinchu (TW)

(72) Inventors: Wen-Chih Lin, Taoyuan City (TW); Cheng-Yu Kuo, Kaohsiung City (TW); Yen-Hung Chen, Hsinchu (TW); Hsuan-Ting Kuo, Taichung City (TW); Chia-Shen Cheng, Hsinchu (TW); Chao-Wei Li, Hsinchu (TW); Ching-Hua Hsieh, Hsinchu (TW); Wen-Chih Chiou, Zhunan Township (TW); Ming-Fa Chen, Taichung City (TW); Shang-Yun Hou, Jubei City (TW)

(21) Appl. No.: 19/276,375

(22) Filed: Jul. 22, 2025

Related U.S. Application Data
(63) Continuation of application No. 18/403,531, filed on Jan. 3, 2024.
(60) Provisional application No. 63/582,924, filed on Sep. 15, 2023.

(51) Int. Cl. G02B 6/42

(52) U.S. Cl. CPC G02B 6/4214; G02B 6/4244

(57) ABSTRACT

Optical devices and methods of manufacture are presented in which a mirror structure is utilized to transmit and receive optical signals to and from an optical device. In embodiments the mirror structure receives optical signals from outside of an optical device and directs the optical signals through at least one mirror to an optical component of the optical device.

### PRIORITY CLAIM AND CROSS-REFERENCE

This application is a continuation of U.S. patent application Ser. No. 18/403,531, filed Jan. 3, 2024, which claims the benefit of U.S. Provisional Application No. 63/582,924, filed on Sep. 15, 2023, which applications are hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIGS. 10A-10D illustrate an attachment of a first receptacle to the first optical package, in accordance with some embodiments.

FIGS. 11A-11C illustrate an attachment of a first mirror structure, in accordance with some embodiments.

FIG. 12 illustrates transmission of a first optical signal, in accordance with some embodiments.

FIGS. 13A-13B illustrate an attachment of a second mirror structure, in accordance with some embodiments.

FIG. 14 illustrates transmission of the first optical signal in the second mirror structure, in accordance with some embodiments.

FIGS. 15-16 illustrate an attachment process of a third mirror structure and a fourth mirror structure, in accordance with some embodiments.

FIG. 17 illustrates an attachment of the first optical package to an interposer substrate, in accordance with some embodiments.

FIG. 18 illustrates an attachment of the first optical package to a substrate, in accordance with some embodiments.

FIG. 19 illustrates an attachment of the first optical package to a redistribution structure, in accordance with some embodiments.

FIG. 20 illustrates an embodiment utilizing a fifth mirror structure and a sixth mirror structure, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a mirror structure is utilized to route incoming and outgoing optical signals between an optical fiber and an edge coupler of a first optical package. The embodiments presented, however, are intended to be illustrative and are not intended to limit the ideas presented to the precise embodiments described. Rather, the ideas presented may be incorporated into a wide variety of embodiments, and all such embodiments may be included within the overall scope of the disclosure.

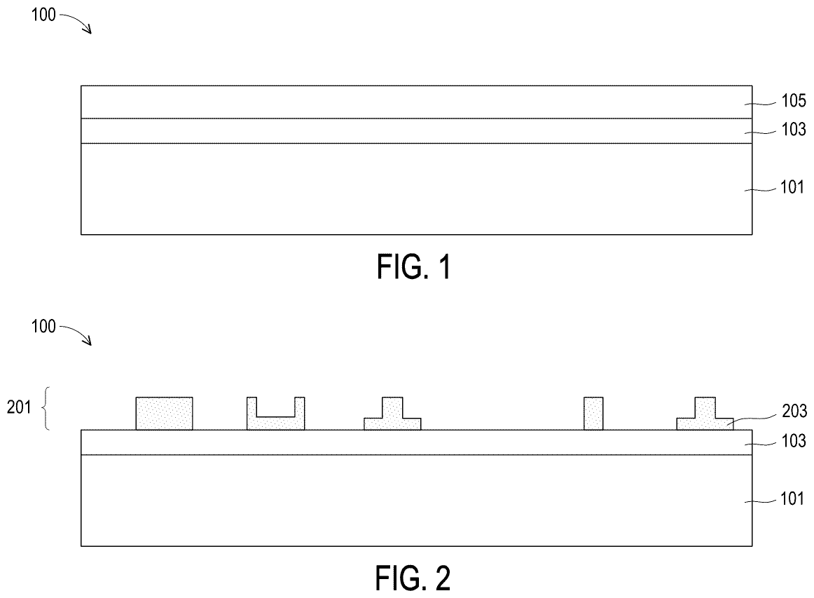

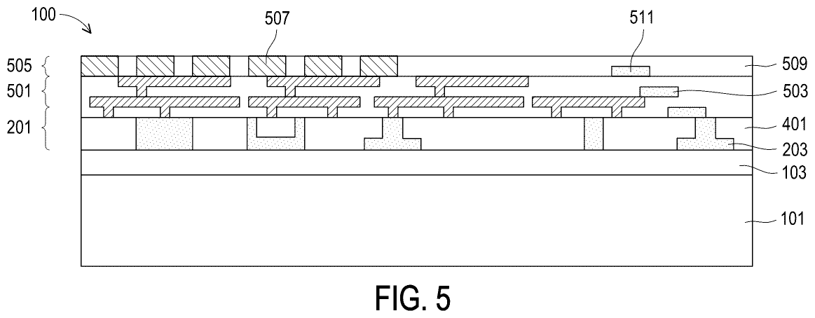

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203.

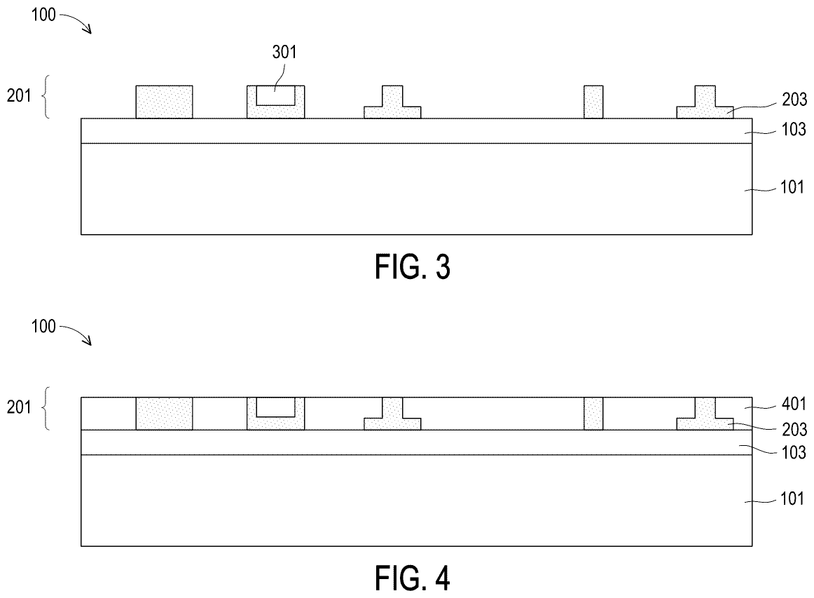

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

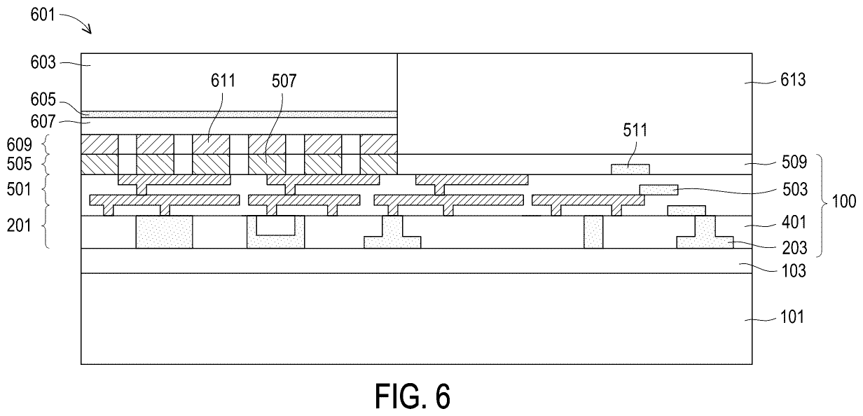

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the first semiconductor device 601. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

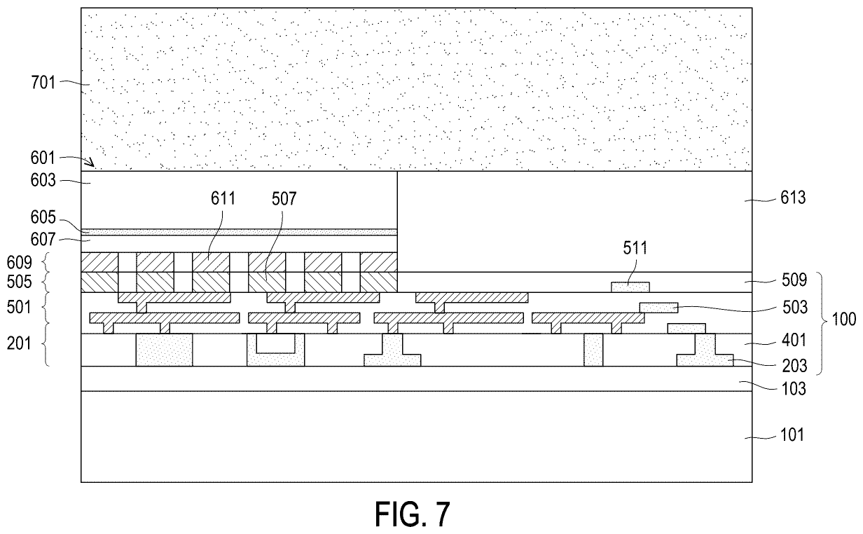

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

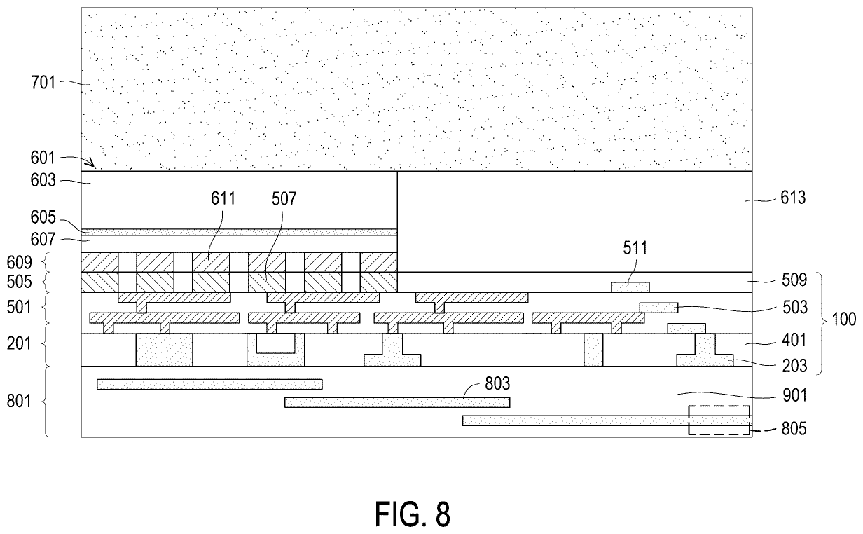

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

Additionally, in an embodiment the fourth optical components 803 of the second active layer 801 may comprise optical couplers in order to receive and transmit optical signals into and out of the second active layer 801. For example, in particular embodiments the fourth optical components 803 may comprise one or more edge couplers (represented by the dashed box labeled 805 in FIG. 8). However, any suitable coupler may be utilized.

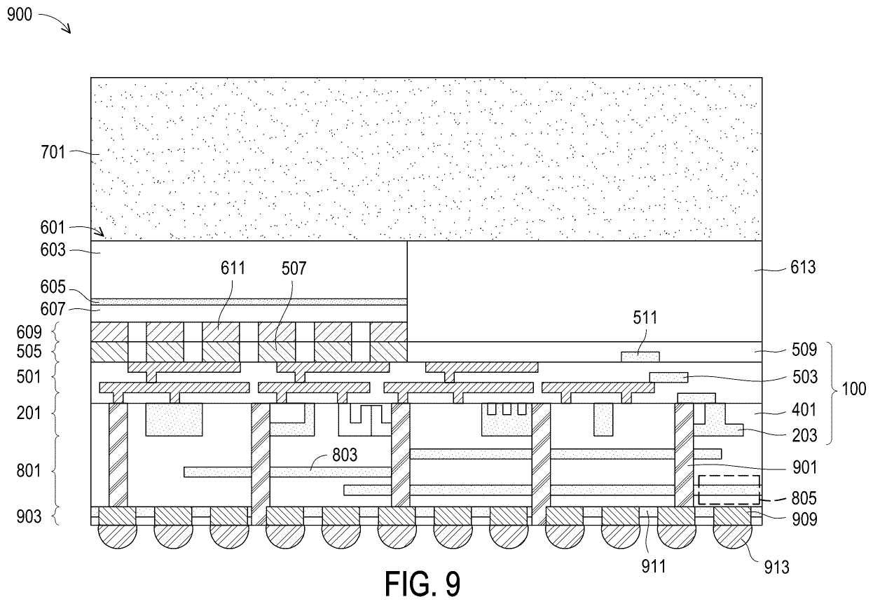

FIG. 9 illustrates formation of first through device vias (TDVs) 901 and formation of a third bonding layer 903 to form a first optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

FIG. 9 additionally illustrates a placement of first external connectors 913 which may be formed to provide conductive regions for contact between the third bond pads 909 to other external devices. The first external connectors 913 may be conductive bumps (e.g., C4 bumps, ball grid arrays, microbumps, etc.) or conductive pillars utilizing materials such as solder and copper. In an embodiment in which the first external connectors 913 are contact bumps, the first external connectors 913 may comprise a material such as tin, or other suitable materials, such as silver, lead-free tin, or copper. In an embodiment in which the first external connectors 913 are tin solder bumps, the first external connectors 913 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

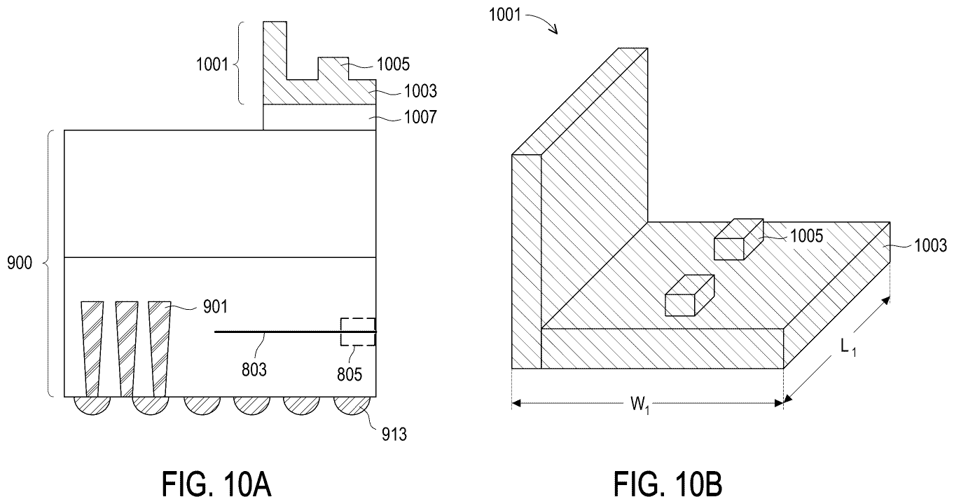

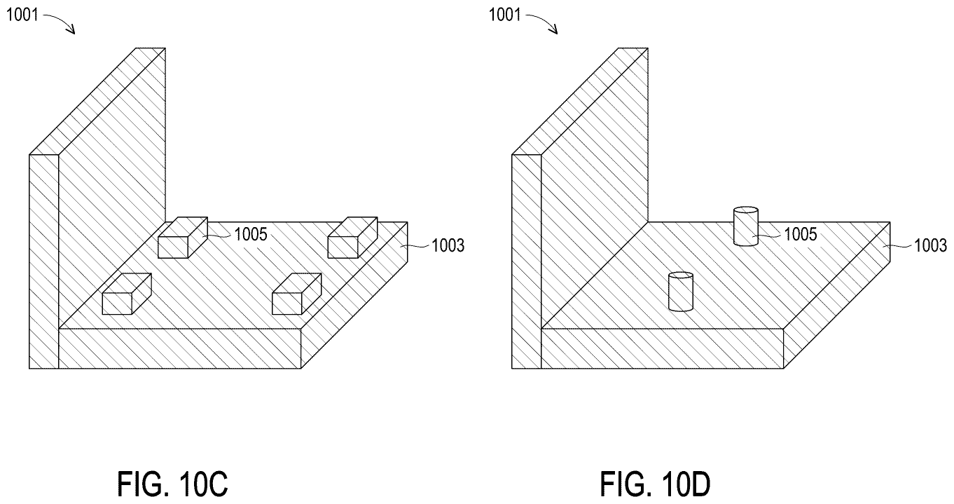

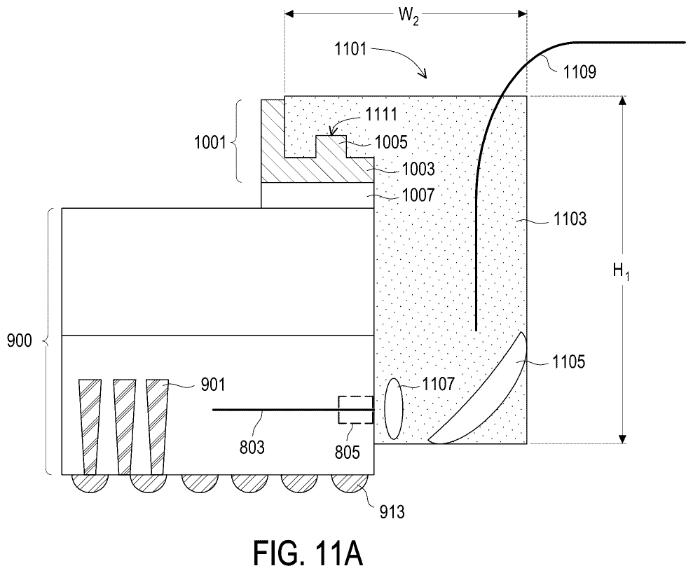

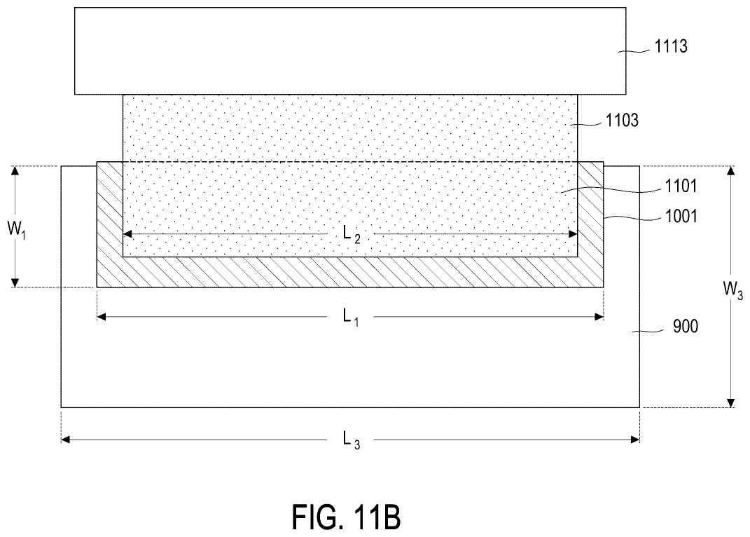

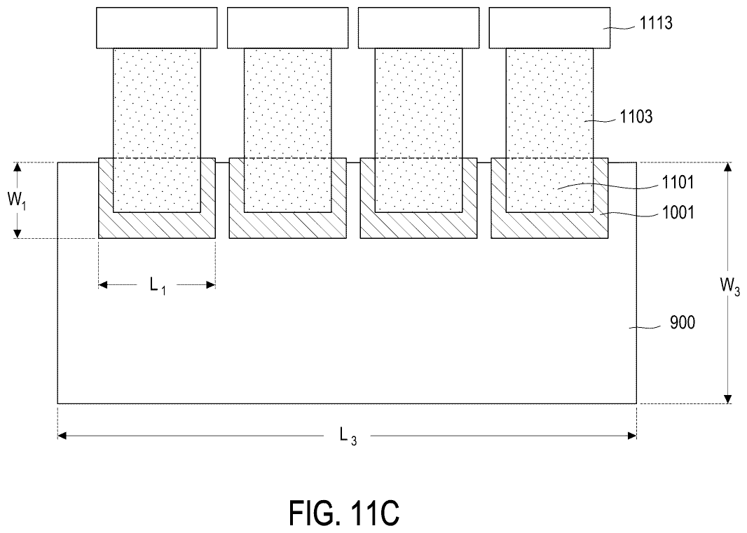

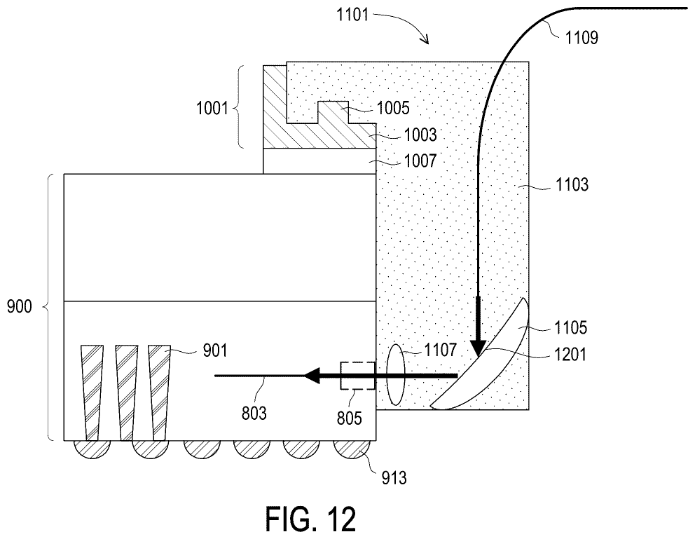

FIG. 10A illustrates that, once the first optical package 900 has been formed, a first receptacle 1001 may be attached to the first optical package 900 (with the first optical package 900 being illustrated in a simplified form for clarity). In an embodiment the first receptacle 1001 may be utilized to attach a first mirror structure 1101 (not illustrated in FIG. 10A but illustrated and discussed further below with respect to FIG. 11A-C) in order to achieve two-dimensional edge coupling (described further below with respect to FIG. 12). In an embodiment the first receptacle 1001 comprises a first connecting portion 1003 to attach the first receptacle 1001 to the first optical package 900 and one or more second connecting portions 1005 to receive and hold the structure with the first mirror structure 1101. The first connecting portion 1003 and the second connecting portion 1005 may be formed as a single integral portion, or the first connecting portion 1003 and the second connecting portion 1005 may be formed separately from each other and then connected together.

Looking at the second connecting portion 1005, the second connecting portions 1005 are utilized in order to receive, hold, and position the first mirror structure 1101 in a particular position. In a particular embodiment the second connecting portions 1005 may comprise one or more sockets arranged into a single row and onto which the first mirror structure 1101 may be placed. However, any suitable connecting structures, in any number or configuration, may be utilized.

FIG. 10B illustrates a perspective view of one particular embodiment of the first receptacle 1001. As can be seen in this figure, the first connecting portion 1003 serves as a support for two of the second connecting portions 1005 in a socket configuration. Looking at the first connecting portion 1003, the first connecting portion may be a flat portion that is suitable for connecting the first receptacle 1001 to the first optical package 900. In a particular embodiment the first connecting portion 1003 may have a first width W₁ of between about 3 mm and about 8 mm, and may have a first length L₁ of between about 3 mm and about 18 mm. However, any suitable dimensions may be utilized. However, any suitable number of the second connecting portions 1005 and any suitable dimensions may be utilized.

FIG. 10C illustrates another embodiment of the first receptacle 1001 in which there are additional ones of the second connecting portions 1005 utilized in order to help hold the first mirror structure 1101 to the first optical package 900. In this embodiment, instead of having a single row of two second connecting portions 1005 (as illustrated in FIG. 10B above), the first receptacle 1001 has at least four of the second connecting portions 1005 arranged in multiple rows. Any suitable number of the second connecting portions 1005 which are arranged in any suitable configuration may be utilized.

FIG. 10D illustrates yet another embodiment of the first receptacle 1001 in which the second connecting portions 1005, instead of being in a socket configuration, are instead formed as guide pins. For example, in this embodiment the second connecting portions 1005 may be formed in cylindrical pin shapes in order to help guide the first mirror structure 1101 and in the particular embodiment illustrated the cylindrical pin shapes may be arranged in a single row. However, any suitable shapes and any suitable arrangement may be utilized.

Returning now to FIG. 10A, once the first receptacle 1001 is prepared, the first receptacle 1001 may be attached to the first optical package 900 using a first adhesive 1007. In an embodiment the first adhesive 1007 may be a removable adhesive such as an adhesive film ultra-violet (UV) glue, or may be formed of other known adhesive materials. In an embodiment, the first adhesive 1007 may be pre-attached onto the first connecting portion 1003 or the first optical package 900. Once the first adhesive 1007 is present where desired, the first receptacle 1001 and the first adhesive 1007 are placed into physical contact with the first optical package 900 in order to adhere the first receptacle 1001 to the first optical package 900. However, any suitable process and materials, or even direct bonding processes, may be utilized.

FIG. 11A illustrates a placement of the first mirror structure 1101 onto the first receptacle 1001. In an embodiment the first mirror structure 1101 comprises a first material 1103, a first mirror 1105, an optional first microlens 1107, and a first optical fiber 1109. In an embodiment the first material 1103 may be a material transparent to the desired optical signals, such as SiO₂, Si, or a polymer, wherein the first material 1103 has a first portion which extends along a first side or sidewall of the first optical package 900 once attached and also has a second portion which extends over a second side or top surface of the first optical package 900 once attached, wherein the first side is perpendicular to the second side. However, any suitable material may be utilized.

In an embodiment the first mirror structure 1101 further comprises one or more openings 1111 within the first material 1103. The openings 1111 are utilized during placement of the first mirror structure 1101 to receive the second connecting portions 1005 of the first receptacle 1001 and hold the first mirror structure 1101 in place. In an embodiment the one or more openings 1111 may be formed using any suitable process, such as etching, drilling, or forming the one or more openings 1111 during manufacture and shaping of the first material 1103.

The first mirror 1105 or lens may either be placed or else formed within the first material 1103. In an embodiment the first mirror 1105 may comprise one or more single mirrors or may comprise a series of one or more mirrors that are part of an integral structure. In an embodiment in which the first mirror 1105 is pre-formed, the first mirror 1105 may be placed and adhered into one or more openings located within the first material 1103. Any suitable method of placing and holding the first mirror 1105 may be used.

In an embodiment in which the first mirror 1105 is formed within the first material 1103 the first mirror 1105 may be formed by initially patterning the first material 1103 to form a recess. In an embodiment the recess may be formed using one or more photolithographic masking and etching processes, such as one or more wet etching processes or dry etching processes. However, any suitable process may be utilized.

Once the recess has been formed, the first mirror 1105 may be formed along sidewalls of the recess. In an embodiment the first mirror 1105 may be a single layer of a reflective material such as aluminum copper, copper, gold, aluminum, titanium nitride, combinations of these, or the like, or else may be a multi-layer structure such as a Braggs reflector comprising alternating layers of different materials, such as alternating layers of silicon dioxide and amorphous silicon. The individual materials of the first mirror 1105 may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). However, any suitable materials and methods may be utilized in order to form the first mirror 1105 along the sidewalls of the recess.

Additionally, if the formation of the first mirror 1105 does not fully fill the recess, the recess may be filled and planarized. In an embodiment the recess may be filled and/or overfilled with a material similar to the first material 1103 deposited using a method such as chemical vapor deposition, followed by a planarization process such as a chemical mechanical polishing process. However, any suitable material and any suitable process may be utilized.

Optionally, the first microlens 1107 may be placed and/or formed adjacent to the first mirror 1105 in order to help focus optical signals (not illustrated in FIG. 11A but illustrated and described further below with respect to FIG. 12) between the first mirror 1105 and the first optical package 900. In an embodiment the first microlens 1107 may be a collimate or convergent type lens with a refractive index of between about 1 and about 3.5 and may be formed by shaping the material of the first material 1103 using masking and etching processes. However, any suitable process may be utilized.

The first optical fiber 1109 may be positioned within the first material 1103 in order to transmit and receive optical signals to and from the first mirror 1105. In an embodiment the first optical fiber 1109 may comprise a core material such as glass surrounded by one or more cladding materials. Optionally, a surrounding cover material may be used to surround the outer cladding material in order to provide additional protection.

The first optical fiber 1109 may be positioned within the first material 1103 such that a first end of the first optical fiber 1109 is parallel with a sidewall of the first optical package 900. As such, optical signals transmitted by the first optical fiber 1109 are directed towards the first mirror 1105 instead of towards, e.g., a grating coupler located within the first optical package 900. In an embodiment the first material 1103 may be patterned to have an opening for the first optical fiber 1109 and the first optical fiber 1109 may be inserted into the first material 1103 and held secure with, e.g., an optical glue (not separately illustrated).

Once the first mirror structure 1101 has been prepared, the first mirror structure 1101 may be attached to the first optical package 900 using the first receptacle 1001. In an embodiment the first mirror structure 1101 is physically placed onto the first receptacle 1001 such that the second connecting portions 1005 enter the corresponding openings 1111 located within the first material 1103. As such, the first mirror structure 1101 is held in place using frictional forces and may be removed. In other embodiments the first mirror structure 1101 may be adhered to the first receptacle 1001 using a glue. Any other suitable method of securing the first mirror structure 1101 may be utilized.

In some embodiments the first mirror structure 1101 may be formed to have a second width W₂ of between about 3 mm and about 8 mm and a second length L₂ (not illustrated in FIG. 11A but illustrated below with respect to FIG. 11B) of between about 1 mm and about 18 mm. Additionally, the first mirror structure 1101 may have a first height H₁ of between about 0.5 mm and about 1 mm. However, any suitable dimensions may be utilized.

FIG. 11B illustrates a top down view of the connections around the first mirror structure 1101 and the first optical package 900. In particular, in the embodiment illustrated in FIG. 11B, a single one of the first mirror structures 1101 may be attached to the first receptacle 1001. Further, within the first mirror structure 1101, a two dimensional array of the first optical fibers 1109 (wherein each individual optical fiber is not illustrated for clarity) in a fiber array unit (FAU) is utilized along with a plurality of the first mirrors 1105 (not separately illustrated) in order to transmit optical signals between the first optical package 900 and, e.g., a ferrule 1113.

In an embodiment, the ferrule 1113 may be used to receive the array of the first optical fibers 1109 (from devices located off of the figure), align the individual first optical fibers 1109, and connect the first optical fibers 1109 to the first mirror structure 1101. In an embodiment, the ferrule 1113 may be a mechanical transfer (MT) ferrule and the like made of a material that can be used to protect, support and align the individual first optical fibers 1109. However, any suitable materials may be utilized. In an embodiment, the first optical fibers 1109 may be inserted into openings located within the ferrule 1113. Once inserted a glue material, such as an epoxy, silicone, a photocurable elastic polymer, combinations of these, or the like, may be injected or otherwise placed into the openings within the ferrule 1113 in order to secure the first optical fibers 1109 within the ferrule 1113. Additionally, a curing process such as a light cure, a heat cure, or the like, may be utilized to harden the glue material. In this embodiment, the ferrule 1113 helps secure the first optical fibers 1109 such that the optical signals provided by the first optical fibers 1109 may be transmitted.

In this top down view of this embodiment the first optical package 900 may have a third width W₃ of between about 5 mm and about 20 mm and may have a third length L₃ of between about 5 mm and about 25 mm. With such dimensions, the first receptacle 1001 may have the first width W₁ of about 8 mm and the first length L₁ of about 18 mm. However, any suitable dimensions may be utilized.

FIG. 11C illustrates another embodiment wherein, instead of a singular ferrule 1113 being utilized, a plurality of individual ferrules 1113 may be utilized. Further, with the use of a plurality of individual ferrules 1113, a plurality of separate arrays of the first optical fibers 1109 and a plurality of individual ones of the first mirror structures 1101 are also used. Any suitable number of ferrules 1113 and any suitable number of individual first mirror structures 1101 may be used. All such structures and any suitable numbers are fully intended to be included within the scope of the embodiments.

In this embodiment the first optical package 900 may maintain a similar size and shape as the embodiment described above with respect to FIG. 11C (e.g., may have the third width W₃ and the third length L₃). In such an embodiment there may be four of the first mirror structures 1101, and each of the first mirror structures 1101 may have the first width W₁ be about 3 mm and may have the first length L₁ be about 3 mm. However, any suitable dimensions may be utilized.

FIG. 12 illustrates a transmission of a first optical signal (represented in FIG. 12 by the arrows labeled 1201) between the first optical fiber 1109 to the edge coupler 805 within the fourth optical components 803 of the first optical package 900. In an embodiment the first optical signal 1201 that is being transmitted to the first optical package 900 exits the first optical fiber 1109 and travels through the first material 1103 to the first mirror 1105. The first mirror 1105 reflects the first optical signal 1201 towards the first microlens 1107, which modulates the first optical signal 1201 and directs the first optical signal 1201 towards the fourth optical components 803. The edge coupler 805 within the fourth optical components 803 receives the first optical signal 1201 and helps move the first optical signal 1201 into the fourth optical components 803.

Similarly, second optical signals (not separately illustrated in FIG. 12) may be transmitted from the first optical package 900 to the first optical fiber 1109. In an embodiment the second optical signals may traverse a similar path as the first optical signal 1201 but in an opposite direction. For example, the second optical signals may be transmitted from the edge coupler 805 within the fourth optical components 803 and through the first microlens 1107 so that the second optical signals impact upon the first mirror 1105. The first mirror 1105 then reflects the second optical signals towards the first optical fibers 1109, which receives the second optical signals and transmits them to external devices (not separately illustrated).

Of course, while the direction of the first optical signal 1201 and the second optical signal are described above as being received and transmitted by the edge coupler 805 within the fourth optical components 803, this is merely intended to be illustrative and is not intended to limit the embodiments. Rather, the first mirror structure 1101 may be designed and used to direct the optical signals into any of the optical components within the first optical package 900. For example, the first mirror structure 1101 may direct the optical signals into the first optical components 203, the second optical components 503, or the third optical components 511. All such directions are fully intended to be included within the scope of the embodiments.

By utilizing the first mirror structure 1101, the optical signals may be transmitted through the edge coupler 805 located within the fourth optical components 803. As such, the use of a grating coupler, which can limit operating bandwidths and may be polarization sensitive, can be avoided. Without the limits on the operating bandwidths, a higher coupling efficiency can be obtained, leading to a larger bandwidth, polarization independence, and an overall more efficient device.

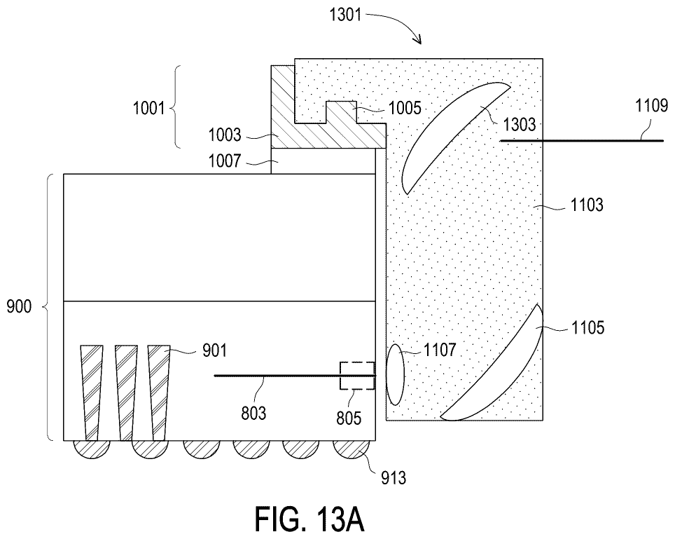

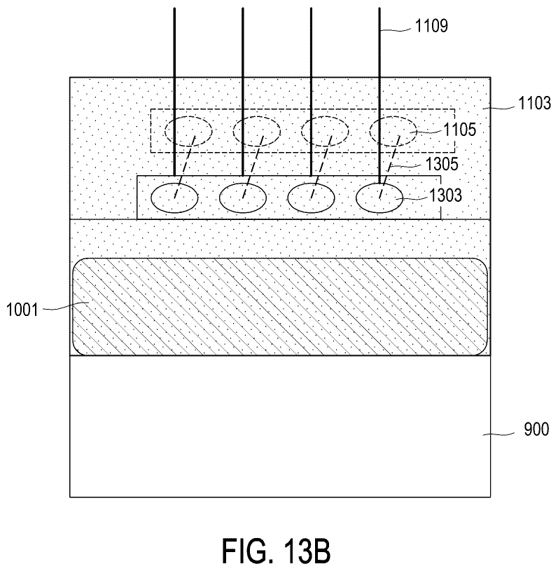

FIGS. 13A-13B illustrate a cross-sectional view and a top down view, respectively, of a second mirror structure 1301 that may be used in order to adjust the first optical signals 1201 and the second optical signals such that they may be received by an edge coupler instead of a grating coupler. In this embodiment, however, instead of using the first mirror 1105 to reflect the signals from an optical fiber that has been placed parallel with an edge of the first optical package 900, the first optical fiber 1109 is placed parallel with a top surface of the first optical package 900 and a second mirror 1303 is utilized to reflect the optical signals towards the first mirror 1105.

Looking at the second mirror 1303, the second mirror 1303 may be formed and placed using similar materials and processes as the first mirror 1105, described above with respect to FIG. 11A-C. For example, the second mirror 1303 may be a mirror array or one or more individual mirrors that are placed within the first material 1103, or else are deposited within the first material 1103 using etching and deposition processes. However, any suitable methods may be used to form and/or place the second mirror 1303.

FIG. 13B illustrates a top down view of an array of the second mirrors 1303 (represented in FIG. 13B by the box surrounding each of the second mirrors 1303). As can be seen in this figure, the second mirror 1303 is positioned and oriented to accept the optical signals from the first optical fiber 1109 and reflect the optical signals to the first mirror 1105, even if the orientation is such that the first mirrors 1105 are offset from second mirrors 1303 in a top down view (as represented in FIG. 13B by the dashed line labeled 1305). As such, any suitable orientation of the first mirror 1105 and the second mirror 1303 that can guide light between the first optical fiber 1109 and an edge coupler of the fourth optical components 803.

Once the second mirror structure 1301 has been prepared with the first mirrors 1105 and the second mirrors 1303, the second mirror structure 1301 may be attached to the first optical package 900 using the first receptacle 1001. In an embodiment the second mirror structure 1301 is attached as described above with respect to FIG. 11A, such as by inserting the second connecting portions 1005 into openings within the first material 1103 of the second mirror structure 1301. However, any suitable method of attachment may be utilized.

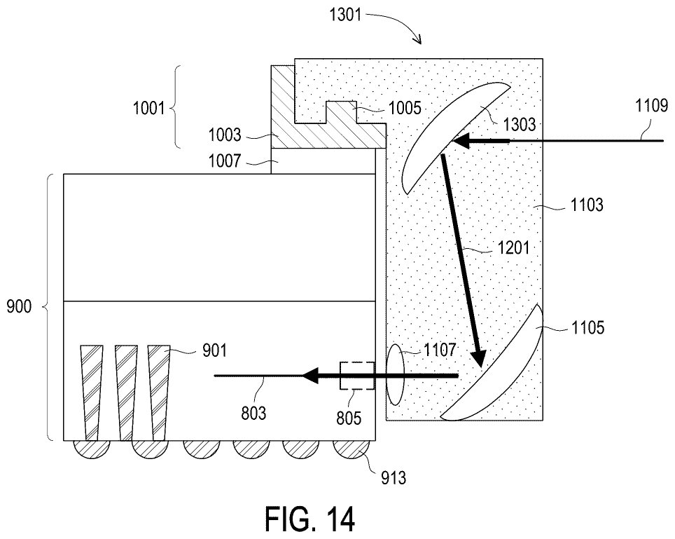

FIG. 14 illustrates that, in operation, the first optical fiber 1109 in this embodiment enters the second mirror structure 1301 (once the second mirror structure 1301 is attached to the first optical package 900) parallel with a top surface of the first optical package 900 so that optical signals (e.g., the first optical signal 1201) that exit the first optical fiber 1109 are directed towards the second mirror 1303. The first optical signal 1201 is then reflected by the second mirror 1303 towards the first mirror 1105. The first mirror 1105 receives the first optical signal 1201 and reflects the first optical signal 1201 through the optional first microlens 1107 and into the first optical package 900, where it is received by the edge coupler 805 within the fourth optical components 803.

Similarly, second optical signals (not illustrated in FIG. 14) may be transmitted from the edge coupler 805 within the fourth optical components 803 through the optional first microlens 1107 and towards the first mirror 1105. The first mirror 1105 receives the second optical signals and reflects them towards the second mirror 1303. The second mirror 1303 receives the second optical signals from the first mirror 1105 and reflects the second optical signals into the first optical fiber 1109. As such, the second optical signals may be transmitted by the first optical package 900.

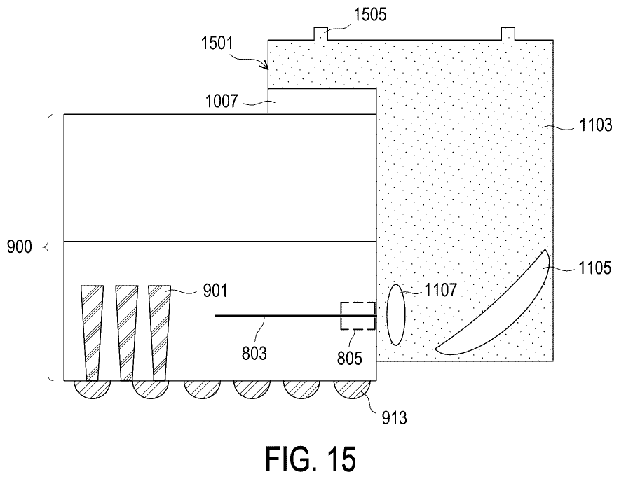

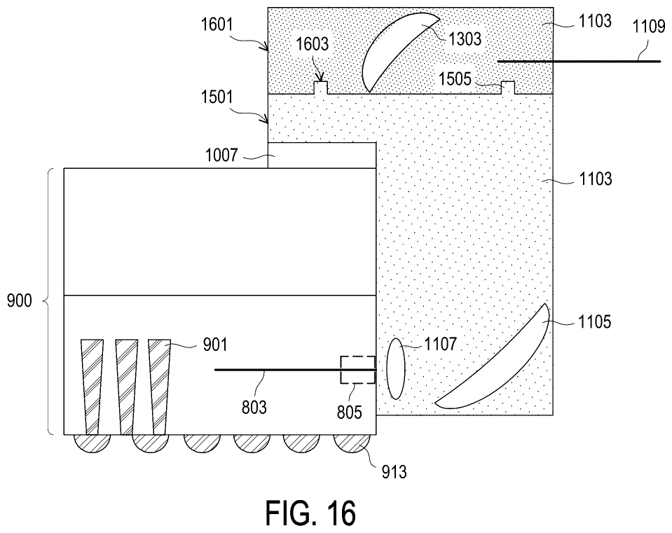

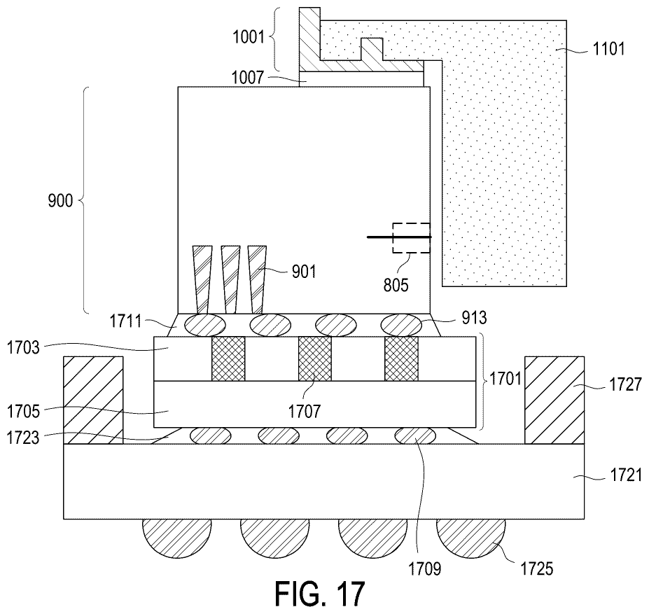

FIG. 15 illustrates another embodiment which uses a third mirror structure 1501 and a fourth mirror structure 1601 (not illustrated in FIG. 15 but illustrated and described further below with respect to FIG. 16) which collectively can be used with or without the first receptacle 1001 (wherein the embodiment illustrated is without the first receptacle). In this embodiment the third mirror structure 1501 may be similar to the first mirror structure 1101, such as having the first mirror 1105, the first microlens 1107, and also having a portion which extends over the first optical package 900.

In this embodiment, however, the first optical fiber 1109 is not located within the third mirror structure 1501. Rather, instead of the first optical fiber 1109, the third mirror structure 1501 additionally comprises third connecting portions 1505 that can be used to position and hold the fourth mirror structure 1503. In an embodiment the third connecting portions 1505 may be similar to the second connecting portions 1005, described above with respect to FIGS. 10A-10D. For example, the third connecting portions 1505 may be a similar material as the first material 1103, and may be formed by etching and/or otherwise shaping the first material 1103, or else may be detachable from the remainder of the first material 1103. However, any suitable materials and methods may be utilized.

Once the third mirror structure 1501 has been formed or otherwise prepared, the third mirror structure 1501 may be attached to the first optical package 900. However, because the first receptacle 1001 is not present in the illustrated embodiment, the third mirror structure 1501 is attached directly to the first optical package 900 using, e.g., the first adhesive 1007. However, in other embodiments the third mirror structure 1501 may be attached using the first receptacle 1001. Any suitable methods of attaching the third mirror structure 1501 may be utilized.

FIG. 16 illustrates that, either after to or prior to the attachment of the third mirror structure 1501 to the first optical package 900, the fourth mirror structure 1601 may be placed and/or attached to the third mirror structure 1501. In an embodiment the fourth mirror structure 1601 may comprise the second mirror 1303 embedded within the first material 1103. Additionally, the fourth mirror structure 1601 may receive the first optical fiber 1109 aligned with the second mirror 1303.

FIG. 16 additionally illustrates that the fourth mirror structure 1601 comprises second openings 1603 that help attach the fourth mirror structure 1601 to the third mirror structure 1501. As such, the second openings 1603 within the fourth mirror structure 1601 have a design that corresponds with the design of the respective third connecting portions 1505 of the third mirror structure 1501. To place the fourth mirror structure 1601 onto the third mirror structure 1501, the second openings 1603 within the fourth mirror structure 1601 may be aligned with the third connecting portions 1505 and the third connecting portions 1505 are inserted into the second openings 1603 within the fourth mirror structure 1601.

FIG. 17 illustrates that, once the first mirror structure 1101, the second mirror structure 1301, or the third mirror structure 1501 and fourth mirror structure 1601 have been attached to the first optical package 900 (with FIG. 17 illustrating a simplified form of the first mirror structure 1101), the first optical package may be attached to an interposer substrate 1701 that is used to couple the first optical package 900 with other devices to form, for example, a chip-on-wafer-on-substrate (CoWOS®) device. In an embodiment the interposer substrate 1701 comprises a semiconductor substrate 1703, third metallization layers 1705, third through device vias (TDVs) 1707, and second external connectors 1709. The semiconductor substrate 1703 may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate 1703. The first active devices comprise a wide variety of active devices and passive devices such as capacitors, resistors, inductors and the like that may be used to generate the desired structural and functional requirements of the design for the semiconductor substrate 1703. The first active devices may be formed using any suitable methods either within or else on the semiconductor substrate 1703.

The third metallization layers 1705 are formed over the semiconductor substrate 1703 and the first active devices and are designed to connect the various devices to form functional circuitry. In an embodiment the third metallization layers 1705 are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, at any desired point in the manufacturing process, the second TDVs 1707 may be formed within the semiconductor substrate 1703 and, if desired, one or more layers of the third metallization layers 1705, in order to provide electrical connectivity from a front side of the semiconductor substrate 1703 to a back side of the semiconductor substrate 1703. In an embodiment the second TDVs 1707 may be formed by initially forming through device via (TDV) openings into the semiconductor substrate 1703 and, if desired, any of the overlying third metallization layers 1705 (e.g., after the desired third metallization layer has been formed but prior to formation of the next overlying third metallization layer). The TDV openings may be formed by applying and developing a suitable photoresist, and removing portions of the underlying materials that are exposed to a desired depth. The TDV openings may be formed so as to extend into the semiconductor substrate 1703 to a depth greater than the eventual desired height of the semiconductor substrate 1703.

Once the TDV openings have been formed within the semiconductor substrate 1703 and/or any third metallization layers 1705, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate 1703 may be thinned until the second TDVs 1707 have been exposed. In an embodiment the semiconductor substrate 1703 may be thinned using, e.g., a chemical mechanical polishing process, a grinding process, or the like. Further, once exposed, the semiconductor substrate 1703 may be recessed using, e.g., one or more etching processes, such as a wet etch process in order to recess the semiconductor substrate 1703 so that the second TDVs 1707 extend out of the semiconductor substrate 1703.

In an embodiment the second external connectors 1709 may be placed on the third metallization layers 1705 and may be, e.g., a ball grid array (BGA) which comprises a eutectic material such as solder, although any suitable materials may be used. Optionally, an underbump metallization or additional metallization layers (not separately illustrated in FIG. 17) may be utilized between the third metallization layers 1705 and the second external connectors 1709. In an embodiment in which the second external connectors 1709 are solder bumps, the second external connectors 1709 may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the second external connectors 1709 have been formed, a test may be performed to ensure that the structure is suitable for further processing.

Once the interposer substrate 1701 has been formed, the first optical package 900 may be attached to the interposer substrate 1701. In an embodiment the first optical package 900 may be attached to the interposer substrate 1701 by aligning the first external connectors 913 with conductive portions of the interposer substrate 1701. Once aligned and in physical contact, the first external connectors 913 are reflowed by raising the temperature of the first external connectors 913 past a eutectic point of the first external connectors 913, thereby shifting the material of the first external connectors 913 to a liquid phase. Once reflowed, the temperature is reduced in order to shift the material of the first external connectors 913 back to a solid phase, thereby bonding the first optical package 900 to the interposer substrate 1701.

Optionally, a first underfill material 1711 may be placed. The first underfill material 1711 may reduce stress and protect the joints resulting from the reflowing of the first external connectors 913. The first underfill material 1711 may be formed by a capillary flow process after the first optical package 900 has been attached.

Once the first optical package 900 has been bonded to the interposer substrate 1701, the interposer substrate 1701 may be bonded to a second substrate 1721 with, e.g., the second external connectors 1709. In an embodiment the second substrate 1721 may be a package substrate, which may be a printed circuit board (PCB) or the like. The second substrate 1721 may include one or more dielectric layers and electrically conductive features, such as conductive lines and vias. In some embodiments, the second substrate 1721 may include through-vias, active devices, passive devices, and the like. The second substrate 1721 may further include conductive pads formed at the upper and lower surfaces of the second substrate 1721.

The second external connectors 1709 may be aligned with corresponding conductive connections on the second substrate 1721. Once aligned the second external connectors 1709 may then be reflowed in order to bond the second substrate 1721 to the interposer substrate 1701. However, any suitable bonding process may be used to connect the interposer substrate 1701 to the second substrate 1721.

Optionally, a second underfill material 1723 may be placed. The second underfill material 1723 may reduce stress and protect the joints resulting from the reflowing of the second external connectors 1709. The second underfill material 1723 may be formed by a capillary flow process after the interposer substrate 1701 has been attached.

Additionally, the second substrate 1721 may be prepared for further connections by placing a ring structure 1727 on a side of the second substrate 1721 with the interposer substrate 1701 and by placing third external connections 1725 on an opposite side of the second substrate 1721 from the first optical package 900. In an embodiment the ring structure 1727 may be a structure used for structural support or heat removal, and may be attached using an adhesive (not separately illustrated in FIG. 17). Further, the third external connections 1725 may be formed using similar processes and materials as the second external connectors 1709. However, any suitable materials and processes may be utilized.

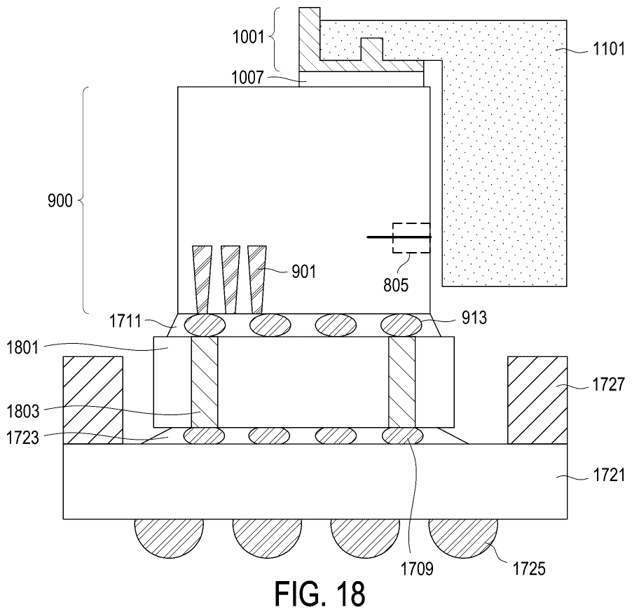

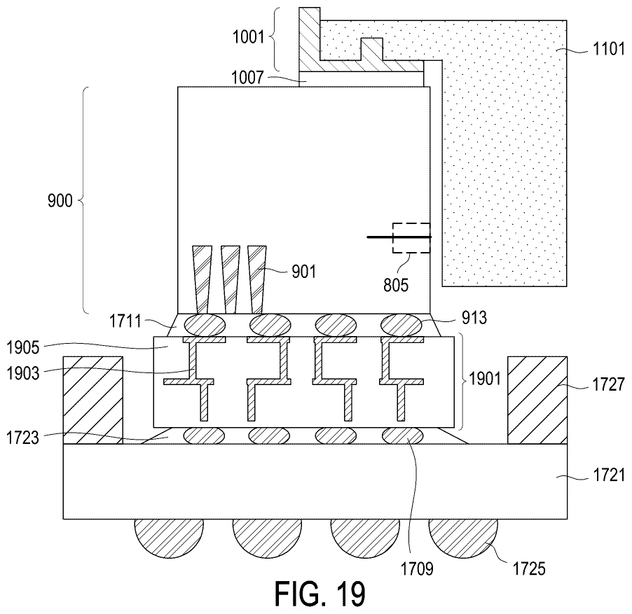

FIG. 18 illustrates another embodiment in which the first optical package 900 is bonded to an external device. In the embodiment illustrated in FIG. 18, however, instead of bonding the first optical package 900 to the interposer substrate 1701 (e.g., the silicon interposer) as described with respect to FIG. 17, the first optical package 900 is bonded directly to a second semiconductor substrate 1801. In an embodiment the second semiconductor substrate 1801 may be similar materials as the semiconductor substrate 1703, such as by being a silicon substrate. However, any suitable material may be utilized.

Additionally in this embodiment, third TDVs 1803 may be formed to extend through the second semiconductor substrate 1801 and provide electrical connectivity between one side of the second semiconductor substrate 1801 to another side of the second semiconductor substrate 1801. In an embodiment the third TDVs 1803 may be formed using similar processes and materials as the second TDVs 1707 described above with respect to FIG. 17. For example, the third TDVs 1803 may be formed by forming an opening, filling the opening with conductive materials, and then thinning the second semiconductor substrate 1801 to expose the conductive materials. However, any suitable methods and materials may be utilized.

Once the second semiconductor substrate 1801 and the third TDVs 1803 are prepared, the first optical package 900 may be bonded to the second semiconductor substrate 1801, and the second semiconductor substrate 1801 may be bonded to the second substrate 1721. In an embodiment the bonding may be performed as described above with respect to FIG. 17. However, any suitable methods and materials may be utilized.

FIG. 19 illustrates another embodiment in which the first optical package 900 is bonded to an external device. In the embodiment illustrated in FIG. 19, however, instead of bonding the first optical package 900 to the interposer substrate 1701 (as described with respect to FIG. 17) or to a second semiconductor substrate 1801 (as described with respect to FIG. 18), the first optical package 900 is bonded to a redistribution structure 1901. In an embodiment the redistribution structure 1901 comprises multiple levels of conductive materials 1903 and molding materials 1905, formed by initially plating each level of conductive materials 1903 and then placing a molding material 1905 such as molding compound to cover each level of conductive material 1903 and then repeating the process. However, any suitable material may be utilized.

Once the redistribution structure 1901 is prepared, the first optical package 900 may be bonded to the redistribution structure 1901, and the redistribution structure 1901 may be bonded to the second substrate 1721. In an embodiment the bonding may be performed as described above with respect to FIG. 17. However, any suitable methods and materials may be utilized.

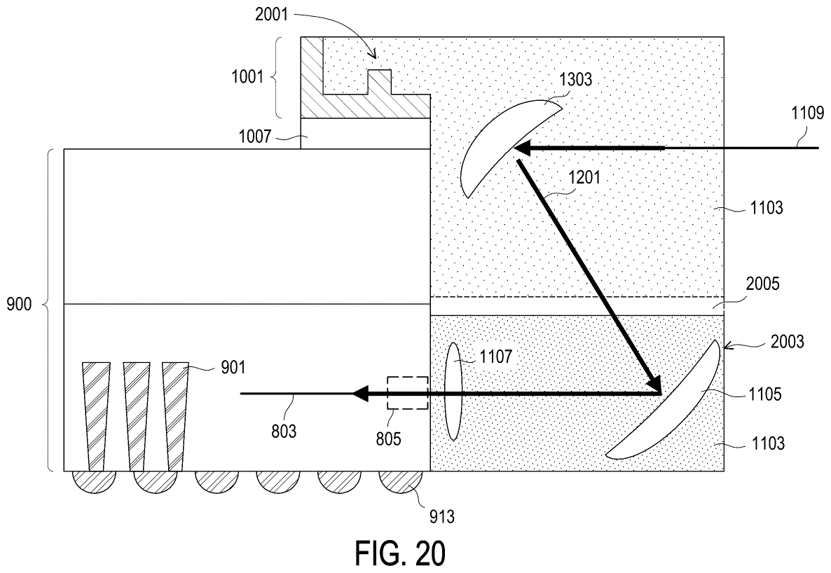

FIG. 20 illustrates yet another embodiment in which multiple mirror structures are connected and joined to the first optical package 900. In the embodiment illustrated herein, however, instead of the third mirror structure 1501 and the fourth mirror structure 1601 being connected by the third connecting portions 1505, a fifth mirror structure 2001 and a sixth mirror structure 2003 are connected by a glue 2005.

Looking first at the fifth mirror structure 2001, in this embodiment the fifth mirror structure 2001 comprises the second mirror 1303 and the first optical fiber 1109 within the first material 1103. The fifth mirror structure 2001 further comprises the openings 1111 to connect the fifth mirror structure 2001 to the first receptacle 1001, and has a planar bottom surface for attachment to the sixth mirror structure 2003.

The sixth mirror structure 2003 comprises the first mirror 1105 and the optional first microlens 1107 within the first material 1103, and is formed separately from the fifth mirror structure 2001. Further, the sixth mirror structure 2003 has a planar top surface for attachment to the fifth mirror structure 2001. However, any suitable shapes may be utilized.

In an embodiment the fifth mirror structure 2001 is adhered to the sixth mirror structure 2003 either prior to or after attachment of the fifth mirror structure 2001 to the first receptacle 1001. In an embodiment the fifth mirror structure 2001 may be adhered to the sixth mirror structure 2003 using an adhesive 2005 that is transparent to the optical signals, and may be, for example, an optical glue, an ultraviolet agent, or the like. However, any suitable adhesive may be utilized.

Once the fifth mirror structure 2001 has been adhered to the sixth mirror structure 2003, the fifth mirror structure 2001 may be attached to the first receptacle 1001 as described above with respect to FIG. 11A, and optical signals may be transmitted through both the fifth mirror structure 2001 and the sixth mirror structure 2003. For example, the first optical signal 1201 may exit the first optical fiber 1009, be reflected by the second mirror 1303, pass through the adhesive 2005, be reflected by the first mirror 1105, pass through the optional first microlens 1107, and be captured by the edge coupler 805. However, any suitable pathway may be utilized.

By utilizing the mirror structures as described herein, co-packaged optical devices can avoid the use of grating couplers in the transmission and receiving of optical signals into and out of the optical devices. In particular, by using the mirror structures the optical signals from an optical fiber can be routed into a plane that comprises an edge coupler, thereby obviating the use of a grating coupler. As such, the limits on operating bandwidth and polarization sensitivity can be avoided, allowing for a faster, more efficient device.

In an embodiment, a method of manufacturing an optical device includes: receiving a first optical package; and attaching a first mirror structure to the first optical package, wherein after the attaching the first mirror structure a first mirror within the first mirror structure is aligned with an edge coupler within the first optical package and wherein after the attaching the first mirror structure a first optical fiber is located within the first mirror structure. In an embodiment the first mirror structure comprises a first microlens. In an embodiment the first optical fiber is aligned to send optical signals to the first mirror. In an embodiment the first mirror structure comprises a second mirror. In an embodiment the first optical fiber is aligned to send optical signals to the second mirror. In an embodiment the attaching the first mirror structure includes: attaching a first receptacle to the first optical package; and attaching the first mirror structure to the first receptacle. In an embodiment the attaching the first mirror structure comprises attaching the first mirror structure directly to the first optical package with an adhesive.

In another embodiment, a method of manufacturing an optical device, the method includes: forming a first optical package, the first optical package comprising an edge coupler; placing an adhesive onto the first optical package; adhering a first mirror structure to the adhesive, wherein after the adhering the first mirror structure a first mirror within the first mirror structure is aligned with the edge coupler; and connecting a second mirror structure to the first mirror structure, the second mirror structure comprising a second mirror and a first optical fiber. In an embodiment after the adhering the first mirror structure a first microlens is located between the first mirror and the edge coupler. In an embodiment the adhering the first mirror structure to the adhesive places the first mirror structure in physical contact with the adhesive. In an embodiment the method further includes attaching the first optical package onto an interposer substrate. In an embodiment the method further includes attaching the first optical package onto a silicon substrate. In an embodiment the method further includes attaching the first optical package onto a redistribution structure. In an embodiment the first mirror comprises an array of mirrors.

In yet another embodiment an optical device includes: a first optical package; and a first mirror structure adhered to the first optical package, the first mirror structure including: a first mirror aligned with an edge coupler within the first optical package; and a first optical fiber. In an embodiment the first optical fiber is aligned parallel with a sidewall of the first optical package. In an embodiment the first mirror structure further comprises a second mirror, the second mirror being aligned with an output of the first optical fiber. In an embodiment the first mirror structure includes: a first portion comprising the first mirror; and a second portion comprising the second mirror, the first portion extending into the second portion. In an embodiment the optical device further includes a microlens located within the first mirror structure and located between the first mirror and the edge coupler. In an embodiment the first mirror structure is adhered to the first optical package with a first receptacle.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. (canceled)

2. An optical device comprising:
a first optical package, the first optical package comprising:
a first active layer of optical components;
an edge coupler;
a semiconductor device bonded over the first active layer of optical components; and
a first mirror structure attached to the first optical package, the first mirror structure comprising:
a first mirror aligned with the edge coupler; and
a first optical fiber, wherein an end of the first optical fiber is aligned with the first mirror structure; and
a receptacle connecting the first optical package with the first mirror structure.

3. The optical device of claim 2, wherein the first mirror and the first optical fiber are embedded within silicon oxide.

4. The optical device of claim 2, wherein the receptacle comprises at least one connecting portion extending into the first mirror structure.

5. The optical device of claim 4, wherein the at least one connecting portion has a cylindrical shape.

6. The optical device of claim 4, wherein the at least one connecting portion has a rectangular shape.

7. The optical device of claim 4, wherein the receptacle is attached to the first optical package with an adhesive.

8. The optical device of claim 2, wherein an output of the first optical fiber is aligned with the first mirror.

9. An optical device comprising:
a first optical package, the first optical package comprising an edge coupler;
an adhesive on the first optical package;
a first mirror structure adhered to the adhesive, wherein a first mirror within the first mirror structure is aligned with the edge coupler; and
a second mirror structure connected to the first mirror structure, the second mirror structure comprising a second mirror and a first optical fiber.

10. The optical device of claim 9, further comprising a lens located between the first mirror and the edge coupler.

11. The optical device of claim 9, wherein the first mirror structure comprises connecting portions which extend into the second mirror structure.

12. The optical device of claim 9, further comprising an interposer connected to the first optical package.

13. The optical device of claim 12, further comprising a printed circuit board connected to the interposer.

14. The optical device of claim 9, further comprising a semiconductor substrate connected to the first optical package.

15. The optical device of claim 14, further comprising through vias extending through the semiconductor substrate.

16. An optical device comprising:
an optical engine comprising an optical interposer bonded to a first semiconductor device;
a receptacle attached to the optical engine, the receptacle comprising a plurality of connecting members; and
a first mirror structure located around the plurality of connecting members, the first mirror structure comprising:
a first portion extending over the optical engine; and
a second portion adjacent to a sidewall of the optical engine, the second portion comprising a first mirror aligned with an edge coupler of the optical engine.

17. The optical device of claim 16, wherein the first mirror is embedded within silicon oxide.

18. The optical device of claim 17, further comprising an optical fiber extending into the silicon oxide.

19. The optical device of claim 16, wherein each of the plurality of connecting members is circular in shape.

20. The optical device of claim 16, wherein each of the plurality of connecting members is rectangular in shape.

21. The optical device of claim 16, wherein the receptacle has a first width of between about 3 mm and about 8 mm and has a first length of between about 3 mm and about 18 mm.
